(19) United States
(12) Patent Application Publication
(10) Pub. No.: US 2023/0182979 A1
(43) Pub. Date: Jun. 15, 2023

(54) REUSABLE CONTAINER WITH SELF-CLEANING SURFACE AND IDENTIFICATION DEVICE

(71) Applicant: Redi Technology, Inc., Bedford, MA (US)

(72) Inventors: Laurence B. Sperry, Newton, MA (US); Brian A. Murch, Needham, MA (US)

(21) Appl. No.: 18/080,422

(22) Filed: Dec. 13, 2022

Related U.S. Application Data
(60) Provisional application No. 63/265,426, filed on Dec. 15, 2021.

(51) Int. Cl. B65D 65/38

(52) U.S. Cl. CPC B65D 65/38; B65D 2203/10; B65D 2203/06; B65D 2565/381

(57) ABSTRACT

A reusable food or beverage container that features self-cleaning surface characteristics thereby allowing effective cleaning using minimal resources and effort. The reusable food or beverage container includes an identification device used to associate the reusable food or beverage container as a part of a system of reusable food or beverage containers and associated devices. Successful identification of the reusable food or beverage container allows the container to be accepted for reuse as a part of the reusable container system, as well as to initiate automated processes associated with that particular reusable container.

### CROSS-REFERENCE TO RELATED APPLICATION(S)

This application claims priority to, and the benefit of, co-pending U.S. Provisional Application No. 63/265,426, filed Dec. 15, 2021, for all subject matter common to both applications. The disclosure of said provisional application is hereby incorporated by reference herein in its entirety.

### FIELD OF THE INVENTION

The present invention relates to a reusable food or beverage container used as a part of a commercial reusable container system that is easily washed using minimal resources. In particular, the present invention relates to a container with at least one self-cleaning surface, the reusable container further including an identification device to identify the reusable container as a part of a reusable container system.

### BACKGROUND

There is a growing trend to reduce or eliminate single-use coffee cups. Reusable cup programs have emerged as an alternative to single-use cups, but require extensive resources and logistics to collect and clean the reusable cups prior to being used again. Additionally, because the process of collecting, cleaning, and restocking the reusable cups often takes 24 hours or more, the reusable cup program requires multiples of excess quantities of cups beyond the quantity of users of the program to account for the cups being out of circulation at any given time. Coffee shops and cafes often allow customers to bring in their own reusable coffee cups or travel mugs. This trend has a positive impact on reducing the total number of single-use or reusable cups used. Unfortunately, proper cleaning and sanitizing of these reusable cups in such a way that they are safe to be handled and filled by the baristas or servers requires extensive resources. Additionally, the time and effort required to properly clean and sanitize the cups often prevents users from choosing to bring their own reusable containers. Incentives, such as discounts on drinks, are often used to encourage customers to bring their own reusable cups. However, these incentives are often not enough to overcome the perceived inconvenience by customers, such as not being able to order prior to arrival or making use of automatic payments using a mobile application.

While prior systems have focused on the tracking the deployment, receipt, and washing of such re-usable containers within the system, these systems have not focused on making the reusable container itself easier or more convenient to wash and use by a user.

### SUMMARY

There is a need for a reusable food or beverage container that requires minimal resources to appropriately rinse and sanitize prior to reuse. In order to incentivize the use of such containers, the containers include an identification device particularly configured to enable identification of the specific reusable container as a part of a reusable container system. Identifying the specific reusable container that is being used can trigger automated events, such as automatic ordering, automatic payments, priority service, applying discounts and other incentives, and customer loyalty rewards. The identification device can also be used to enable the reusable container to be used with accompanying devices of the reusable container system, such as allowing the container to be inserted into an automated washing system or sanitizing system. The settings of such systems can also be customized based on known information about the particular reusable container identified, such as customizing wash settings based on the last known contents of the reusable container as well as the type, size, and material of the container.

In accordance with an embodiment of the present invention, a reusable food or beverage container with at least one self-cleaning surface and an identification device is provided. The at least one self-cleaning surface of the reusable food or beverage container enables effective cleaning of the surface using minimal effort and resources, such as completely evacuating all contents when poured out, easily rinsing away residue using only water, or other cleaning and sanitizing methods using minimal effort and resources. The self-cleaning characteristics of the at least one surface also make the reusable food or beverage container easier to dry after rinsing or washing, as the water is effectively removed from the surface using only the force of gravity or with minimal effort such as spinning, shaking, or drying with a cloth. The identification device attached to or embedded in the reusable food or beverage container identifies the container as a part of a reusable container system. By reading the identification device of the reusable food or beverage container, the reusable container system can track the use of reusable food or beverage container, as well as automate systems associated with the container, such as automatic ordering, payments, and discounts.

In accordance with aspects of the present invention, a reusable food or beverage container includes a bottom, at least one side-wall extending from the bottom to define an interior volume and an upper opening at the opposite end of the at least one side-wall from the bottom, and an identification device incorporated into and associated with the reusable food or beverage container. Furthermore, at least one surface of the container comprises a self-cleaning surface. In some aspects, the inner surface of the reusable food or beverage container is self-cleaning. In some aspects, the surface of the lip of the reusable food or beverage container is self-cleaning. In some aspects, the upper outer surface of the reusable food or beverage container is self-cleaning. In some aspects, the outer surface of the reusable food or beverage container is self-cleaning.

In accordance with aspects of the present invention, the reusable food or beverage container includes a removable lid that substantially covers the upper opening of the reusable container. In some aspects, the surfaces of the removable lid of the reusable food or beverage container are self-cleaning. In some aspects, a portion of the surfaces of the removable lid of the reusable food or beverage container is self-cleaning.

In accordance with aspects of the present invention, the identification device of the reusable food or beverage container includes one or more of a bar code, a quick response (QR) code, a near-field communication (NFC) chip, a radio-frequency identification (RFID) tag, or a unique visual marking.

In accordance with aspects of the present invention, the identification device of the reusable food or beverage container associates the reusable food or beverage container with a data store containing information and preferences related to the reusable food or beverage container. In some aspects, the data store contains information to initiate automated processes associated with the reusable food or beverage container. In some aspects, the data store contains information to set parameters of the automated processes associated with the reusable food or beverage container.

In accordance with aspects of the present invention, the self-cleaning surface comprises a superhydrophobic surface. In other aspects, the self-cleaning surface comprises a superoleophobic surface. In still other aspects, the self-cleaning surface comprises a superhydrophilic surface. In further aspects, the self-cleaning surface comprises a photocatalytic surface.

In accordance with aspects of the present invention, the identification device incorporated into and associated with said reusable food or beverage container is disposed in the bottom of the reusable food or beverage container. In still other aspects, the identification device is disposed in the side-wall of the reusable food or beverage container.

In accordance with aspects of the present invention, the reusable food or beverage container comprises a cup. In other aspects, the reusable food or beverage container comprises a take-out food container.

### BRIEF DESCRIPTION OF THE FIGURES

These and other characteristics of the present invention will be more fully understood by reference to the following detailed description in conjunction with the attached drawings, in which:

FIG. 1 is an isometric view of an example reusable food or beverage container;

FIG. 2 is an isometric view an example reusable food or beverage container including a removable lid;

FIG. 3A is a side view of a water droplet on a hydrophobic horizontal surface;

FIG. 3B is a side view of a water droplet on an inclined horizontal surface;

FIG. 3C is a side view of a water droplet on a hydrophilic horizontal surface;

FIG. 4A is an isometric view of the bottom of an example reusable food or beverage container with identification device disposed in the bottom of the container;

FIG. 4B is an isometric view of an example reusable food or beverage container with identification device disposed in the side-wall of the container;

FIG. 5 is diagrammatic illustration of a reusable container system, according to embodiments of the present invention; and

FIG. 6 is a diagrammatic illustration of a computing device and related hardware for use in implementation of the present invention.

### DETAILED DESCRIPTION

Illustrative embodiments of the present invention relate to a reusable food or beverage container with a self-cleaning surface and identification device. The identification device of the reusable food or beverage container identifies the reusable food or beverage container as a part of a reusable container system used by a business or institution, such as a coffee shop, to promote and track the use of reusable containers, such as reusable coffee cups. The reusable food or beverage container features at least one surface with self-cleaning characteristics such that the container is efficiently and effectively cleaned and sanitized using minimal effort, time, and resources. The reusable food or beverage container with a self-cleaning surface and identification device provides a simple, efficient, and easy-to-use replacement for the prevalent use of single-use containers and the associated disposal waste and other environmental issues. Additionally, the reusable food or beverage container with self-cleaning surface and identification device provides a more environmentally friendly alternative to existing reusable containers and systems that require extensive resources for washing, and an excess number of reusable containers to account for reusable containers out of circulation during the washing process.

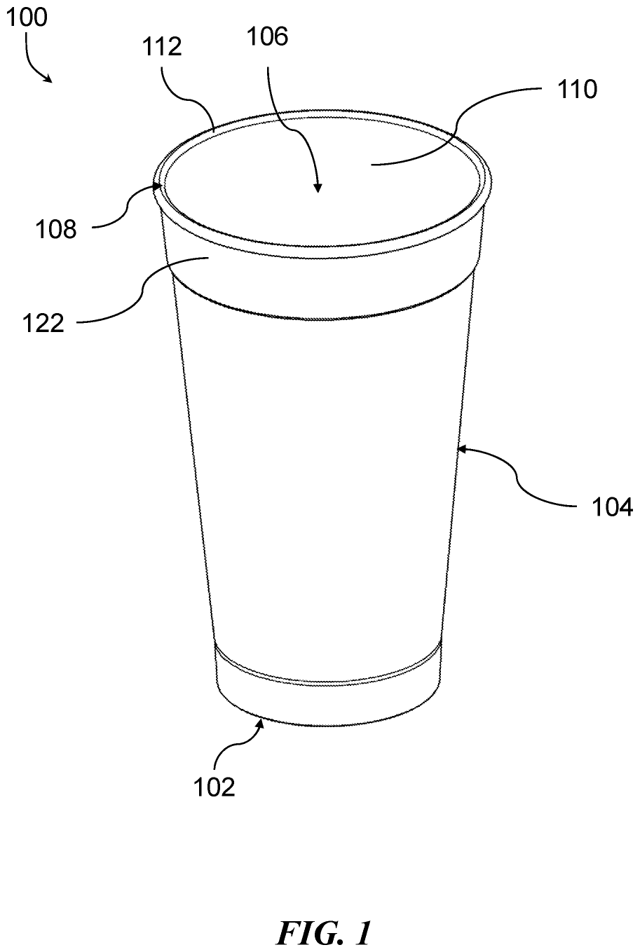

FIGS. 1 through 6, wherein like parts are designated by like reference numerals throughout, illustrate an example embodiment or embodiments of a reusable food or beverage container with a self-cleaning surface and identification device, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 shows an isometric view of a reusable container 100 for food or beverages. The container comprises a bottom 102 and at least one side-wall 104 extending from the bottom 102 to define an interior volume 106 and an upper opening 108 at the opposite end of the at least one side-wall 104 from the bottom 102. The example reusable container 100 depicted in the figures uses a beverage container for the description and figures merely for the purposes of teaching how the invention can be specifically implemented. However, those of skill in the art will readily appreciate that other reusable food or beverage containers can be implemented, such that the present invention is intended to be universally applicable to a variety of reusable food or beverage containers and is not limited to the specific beverage container shown and described. It should also be appreciated that for purposes of efficiency, the figures provided herewith depicting a reusable beverage container are fully applicable to all possible food or beverage containers. For the avoidance of doubt, references to the reusable container are herein transferrable to other food or beverage containers, such as but not limited to, coffee cups, iced coffee cups, tea cups, iced tea cups, carbonated beverage cups, water bottles, to-go restaurant food containers, Asian food take-out containers, other disposable food or beverage containers, and the like, which are considered to all fall within the scope of the present invention.

In the example illustration, the reusable container 100 is in the form of a reusable coffee cup and as such has dimensions that can vary but are generally about 2.25 inches to 2.5 inches for the small diameter, about 3 inches to 3.75 inches for the large diameter, and between about 3.25 inches to about 8 inches of height, for containers with an interior volume 106 capacity range from approximately 6 fluid ounces to 22 fluid ounces. Those of skill in the art will appreciate that these dimensions are approximate and are intended to describe the approximate size and shape of conventional coffee cups, or the like, which conventionally fit in conventional automobile cup holders, and can be found in numerous coffee retail stores. Furthermore, those of skill in the art will appreciate the dimensional attributes are provided for enablement purposes only as it relates to a reusable container 100 for coffee or similar beverage or the like, and can be altered or varied to accommodate different containers of different dimensions for different purposes, and are therefore not limiting of the scope of the invention.

Continuing with FIG. 1, the inner surface 110 of the reusable container 100 is self-cleaning to prevent liquids and debris from adhering to the surface. When liquids and debris do not adhere well to a surface, they more easily roll or slide off the surface due to the force of gravity or other applied force. For the example reusable container 100, the coffee or other beverage contained within the reusable container 100 can be fully evacuated by tipping the reusable container 100 to pour out the contents. The self-cleaning characteristic of the inner surface 110 (with further details provided herein) prevents residual content or residue from the coffee or other beverage from remaining in the reusable container 100. In example embodiments, the surface of the lip 112 of the reusable container 100 is also self-cleaning for the reasons previously described as the coffee or other beverage often will come in contact with the lip 112. In accordance with an example embodiment, the upper outer surface 122 is self-cleaning to prevent any residue from the lips and mouth of the person drinking from the reusable container 100 from adhering to the upper outer surface 122.

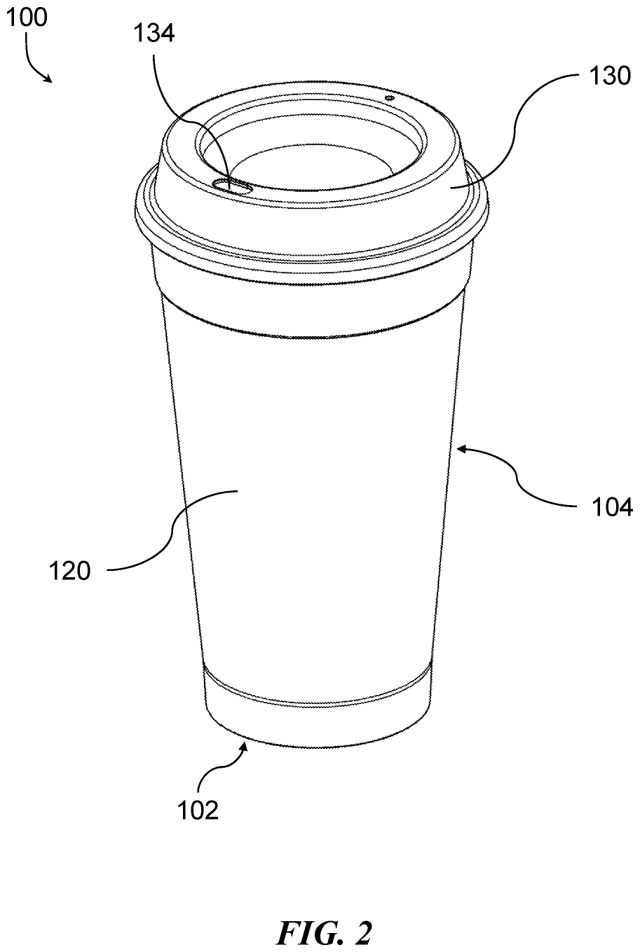

FIG. 2 shows an isometric view of a reusable container 100 including a removable lid 130 which substantially covers the upper opening 108. In embodiments of the invention, the surfaces of the lid 130 are self-cleaning for reasons previously described. In accordance with example embodiments, only surfaces of the lid 130 that are likely to come into contact with the coffee or other beverage, such as the inside of the lid 130, or surfaces that are likely to come into contact with the lips of the drinker, such as surfaces around the lid outlet hole 134, are self-cleaning. In an example embodiment, the outer surface 120 of the reusable container 100 is self-cleaning such that residue from the hands of a person holding the reusable container 100, such as germs and bacteria, are unlikely to adhere to or remain on the outer surface 120.

A self-cleaning surface as utilized herein refers to a class of materials with the inherent ability for liquids, debris, bacteria, and the like to be easily removed or repelled, such as sliding or rolling off from the force of gravity, or rinsed off with water (See the Wikipedia entry for “Self-cleaning surfaces” as of November, 2022 at https://en.wikipedia.org/wiki/Self-cleaning_surfaces#:˜text=Self%2Dcleaning%20surfaces%20are%20a.striders%20to%20na me%20a%20few).

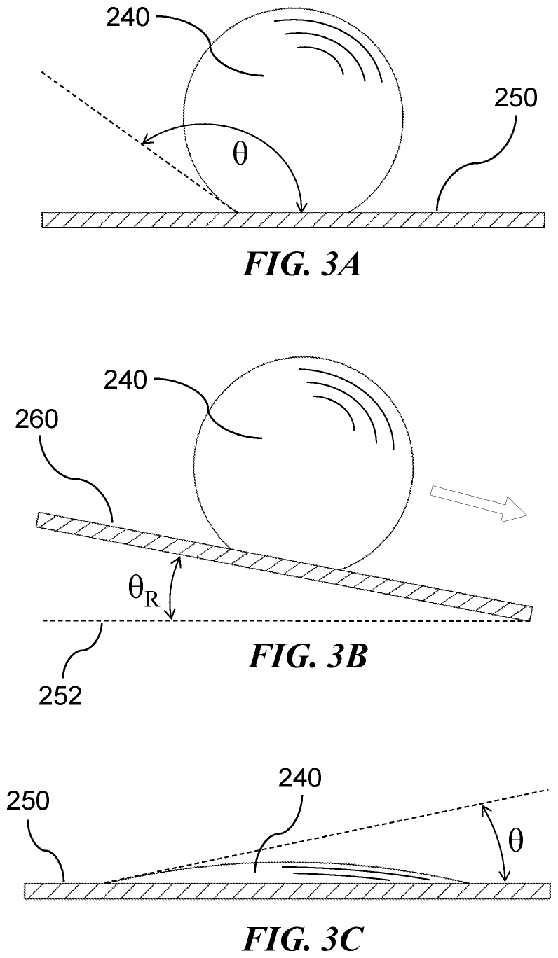

One common type of self-cleaning surface is superhydrophobic, which is a general term for a surface that resists water adhering to the surface, such that the water beads and easily rolls off. FIG. 3A through 3C illustrate the characteristics of water on a surface. FIG. 3A illustrates a water droplet 240 on a horizontal surface 250. Surfaces that resist water, generally referred to as hydrophobic surfaces or non-wettable surfaces, cause the liquid to bead on the surface as opposed to spreading on the surface as water behaves on hydrophilic, or wettable, surfaces. The angle at the contact point between the water droplet 240 and the horizontal surface 250 is the contact angle (θ). A horizontal surface 250 on which the beaded water droplet 240 has a contact angle (θ) of greater than 90° is generally considered to be hydrophobic. The smaller area of the beaded water droplet 240 in contact with the horizontal surface 250 requires less imparted force to move that beaded water droplet 240 across the surface, such as by rolling or sliding. As the contact angle (θ) increases, the contact area decreases, and as such, the beaded water droplet 240 requires less imparted force to move across the horizontal surface 250. Surfaces with a contact angle (θ) of greater than 150° are generally considered to be superhydrophobic.

Another measurable characteristic of superhydrophobic surfaces is a roll-off angle (θ_{R}). FIG. 3B illustrates beaded water droplet 240 on an inclined surface 260. The angle of the inclined surface 260 relative to a horizontal plane 252 at which the beaded water droplet 240 rolls off the surface, as caused only by the force of gravity, is the roll-off angle (θ_{R}). Superhydrophobic surfaces generally have a roll-off angle (θ_{R}) of less than 10° . The given example measurements of a superhydrophobic surface are provided to illustrate the general behavior of a water droplet 240 on surface. However, measurements outside of the provided examples, such as a contact angle (θ) as low as 120° or a roll-off angle (θ_{R}) as high as 20°, of a surface that provide the characteristics of a superhydrophobic surface as described are considered to fall within the spirit and scope of the invention.

Superhydrophobic surfaces are just one example structure and method of creating a self-cleaning surface, but such a surface may only be effective in easily removing water-based liquids from the surface. Various other surface characteristics, or combinations of surface characteristics, can be used to optimize the self-cleaning ability of the surface for a particular type of fluid or debris to be repelled, such as superoleophobic surfaces to repel oil-based liquids or low friction surfaces designed to allow yield-stress fluids, such as gels, to easily slide across the surface.

For self-cleaning surfaces that require debris and bacteria to easily be removed, superhydrophilic surfaces can be used. FIG. 3C illustrates the behavior of a water droplet 240 on a horizontal surface 250 that is superhydrophilic. The extremely low contact angle (θ), such as less than 10°, of a superhydrophilic surface, enables the water droplet 240 to easily spread across the surface as a thin film, as opposed to beading as water does on a superhydrophobic surface. The thin film of water can slide in between the surface and the debris, and as such, the debris is easily rinsed away. One of skill in the art will appreciate that other methods and structures for self-cleaning surfaces, such as but not limited to, a photocatalytic surface that is capable of photocatalysis using a titanium oxide coating exposed to UV light to generate a chemical reaction to breakdown organic matter on the surface, are considered to fall within the spirit and scope of the invention.

Creating an effective self-cleaning surface is a combination of surface texture and surface chemistry. In accordance with aspects of the present invention, the self-cleaning surface can be optimized for the particular contents or a general class of contents that are to be contained within the reusable container 100 (refer to FIG. 1). For the present example reusable container 100 of a reusable coffee cup shown in FIGS. 1 through 2, the inner surface 110 can be optimized to repel the typical liquids (coffee, tea, milk, and the like) and additional ingredients (syrups, sugar, whip cream, frothed milk, and the like) served at coffee shops and cafes, such that the contents of the reusable container 100 are completely evacuated by pouring, or are easily rinsed out using just water. In another example embodiment, the outer surface 120 is optimized to enable the germs, bacteria, and the like that are commonly transferred from a person's hand to the reusable container 100 to easily fall off the outer surface 120 due to the force gravity, or are easily rinsed off with just water. In another example embodiment, all surfaces of the reusable container 100 have the same self-cleaning characteristics. In yet another example embodiment, the different surfaces of the reusable container 100 do not have the same characteristics and are each optimized for desired parameters, such as a self-cleaning inner surface 110 to prevent contents from adhering to the surface, and a textured outer surface 120 for good grip when handling the reusable container 100.

The self-cleaning surface can be the surface of the material of the reusable container 100 itself, such as a superhydrophobic polymer. In another example embodiment, the self-cleaning surface can be an additional material impregnated into the material of the reusable container 100, such as a liquid-impregnated coating saturated into the polymer of the reusable container 100. In yet another example embodiment, the self-cleaning surface can be a coating, such as a spray-on coating applied to the surface of the reusable container 100. These and other structures and methods for creating a self-cleaning surface on a reusable container 100, as appreciated by one of skill in the art, are considered to fall within the spirit and scope of the present invention.

The material of the bottom 102 and at least one side-wall 104 of the reusable container 100 can be any of such material or combination of materials operable for reusable food and beverage containers in accordance with the requirements of the present invention, such as, but not limited to, plastics (polypropylene (PP), polyethylene (PE), acrylonitrile butadiene styrene (ABS), polyetheretherketone (PEEK), and the like), metals (stainless steel, copper, aluminum, titanium, and the like), glass, natural fibers (bamboo, corn husks, and the like) or other such suitable materials. The reusable container 100 can be comprised of one material, such as a single-walled beverage cup or double-walled beverage cup in which the material comprising the inner wall and the outer wall are the same. In an example embodiment, the double-walled reusable container can be comprised of multiple materials, such as stainless steel for the material that comprises the inner wall, and polypropylene for the material that comprises the outer wall. Materials comprising the inner and outer walls of a double-walled reusable container, whether the same material or different materials, can be positioned in close proximity, such as bonded together. In an example embodiment, the inner and outer walls can be spaced apart, such as by an air gap or vacuum chamber between them, as found on thermally insulated reusable food and beverage containers as would be appreciated by one of skill in the art. In an example embodiment, additional materials can be used to enhance the usability or functionality of the reusable container 100, such as an exterior sleeve made of a low heat transfer material (wood, natural fibers, and the like) to protect the hand of a person carrying the reusable container 100 filled with hot contents, or a non-marking bottom pad (rubber, cork, or the like) on the bottom 102 to prevent the reusable container 100 from marking surfaces on to which it is placed.

The materials and chemistries used as additives or coatings used to create a self-cleaning surface can be any of such materials and chemistries commonly used for such purposes. Although known materials and processes, such as polytetrafluoroethylene (PTFE) or copper, can be used to create a self-cleaning surface, many materials, chemistries, and related processes for blending, impregnating, and coating are proprietary, such as, but not limited to, the proprietary technology of Aculon, Chempilots, Nanoslic, SilcoTek, NeverWet, LiquiGlide, and the like, all of which are commercially available. One of skill in the art will appreciate that additives, coatings, chemicals, materials, and design of surface textures can be optimized for a particular use, such as the self-cleaning parameters and durability required for a reusable coffee cup of the present example. One of skill in the art will further appreciate the effective life of self-cleaning surfaces for the present example can be enhanced by the periodic addition of energy, such as by exposure to UV light or heat, such as from the washing process or from the hot beverage or other hot contents of the reusable container 100, to cause a temporary chemical reaction or a particular component to bloom to the surface. Since the contents of the present example reusable coffee cup are intended for human consumption, such as coffee, tea, milk, and the like, the additives, coatings, chemicals, and materials that will come into contact with the contents must be approved for such use by the United States Food and Drug Administration (FDA), or other such equivalent regional or local agency.

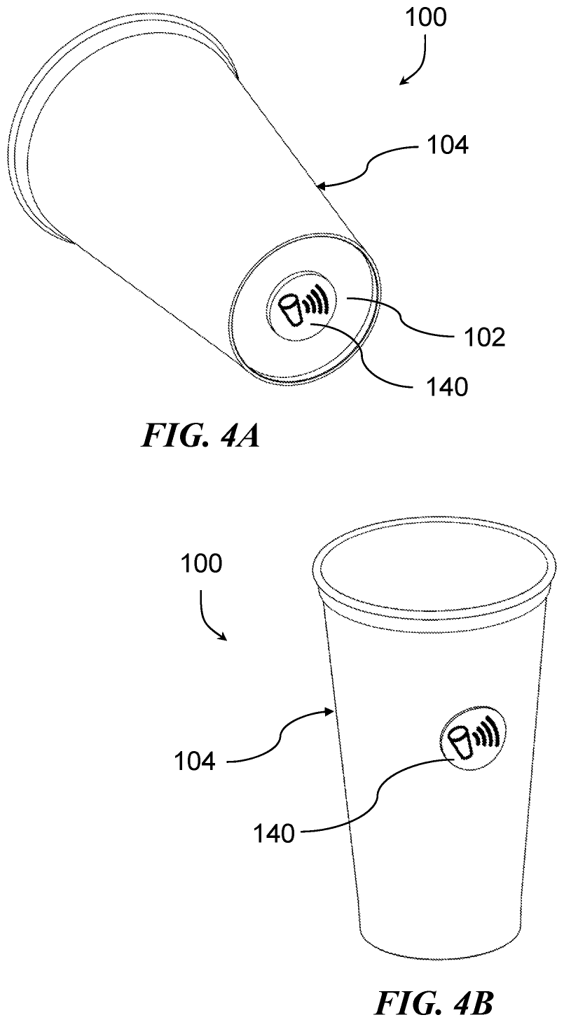

FIG. 4A and FIG. 4B show embodiments of the reusable container 100 with an identification device 140, such as a radio frequency identification (RFID) tag, on or embedded within the reusable container 100. In certain embodiments, such as depicted in FIG. 4A, the identification device 140 is disposed in or on the bottom 102 of the reusable container 100. In other embodiments, such as depicted in FIG. 4B, the identification device is disposed in the side-wall. Various different types of identification systems and technologies, including but not limited to optical protocols such as a bar code, quick response (QR) code, optical symbol or character recognition, other unique visual markings, or transmission protocols such as a near-field communication (NFC) chip, an RFID tag, or the like, are feasible and can be implemented as the identification device 140 of the reusable container 100, as would be appreciated by one of skill in the art.

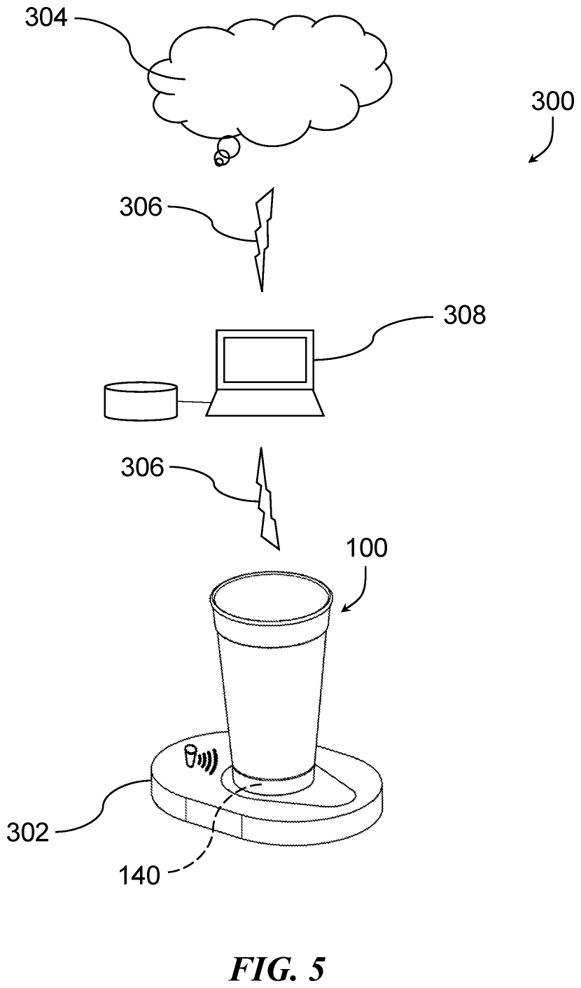

FIG. 5 shows the reusable container 100 with an identification device 140 as a part of a reusable container system 300 to promote, incentivize, and manage the use of such reusable containers 100. At least one reader 302 communicates with an identification device 140 incorporated in the reusable container 100 and exchanges data that characterizes the identification device 140 and associated reusable container 100. A computing device 308, in communication with a data store 304, such as a database or other form of data storage and organization, is a portion of the reusable container system 300 that also includes the identification device 140, the at least one reader 302, and a communication network 306 that enables communication between the components and sharing of data. The communication network 306 can be a local area network, a wide area network, wired, wireless, cloud-based or any other network or data sharing construct understood by those of skill in the art. The computing device 308 can be on premise, e.g., at the same location as the reader 302, or remote in a network, cloud supported, wireless, or wired. Those of skill in the art will additionally appreciate that the location of each component as depicted and described herein can vary such that the components may be combined, integrated, and/or distal, separated, in different combinations and still perform the stated functionality and operation describes herein, all of which combinations are anticipated to fall within the scope of the present invention. The specific hardware and device arrangements described herein are merely representative of one example implementation of the invention and are therefore not intended to be limiting.

At a point of receipt, the identification device 140 is read by a reader 302 of the reusable container system 300 to track the use of the reusable container 100 associated with that identification device 140. In an example embodiment, the reader 302 can initiate or trigger automated events or processes associated with the identification device 140 read, such as but not limited to automatic ordering, automatic payments, priority service, and applying discounts, incentives, and customer loyalty rewards as would be appreciated by one of skill in the art. In an example embodiment, the automated event can be a marking process of the reusable container 100, such as information about the beverage to be contained in the reusable container 100, by printing such information on the reusable container 100 itself, or by printing a label containing such information to be applied, either automatically or manually, to the reusable container 100 as would be appreciated by one of skill in the art.

In an example embodiment of the present invention, the reader 302 can be a part of, or in communication with, other devices of the reusable container system 300, such as enabling the reusable container 100 to be inserted into additional devices of the reusable container system 300, such as automated collection bins, washing systems, and sanitizing systems, such as by ultraviolet (UV) light or the like. In an example embodiment, the settings of the devices of the reusable container system 300 can be optimized based on information related to the reusable container 100 identified by the associated identification device 140, such as customizing the wash settings based on known information about the reusable container 100, such as size, shape, material, or last known contents.

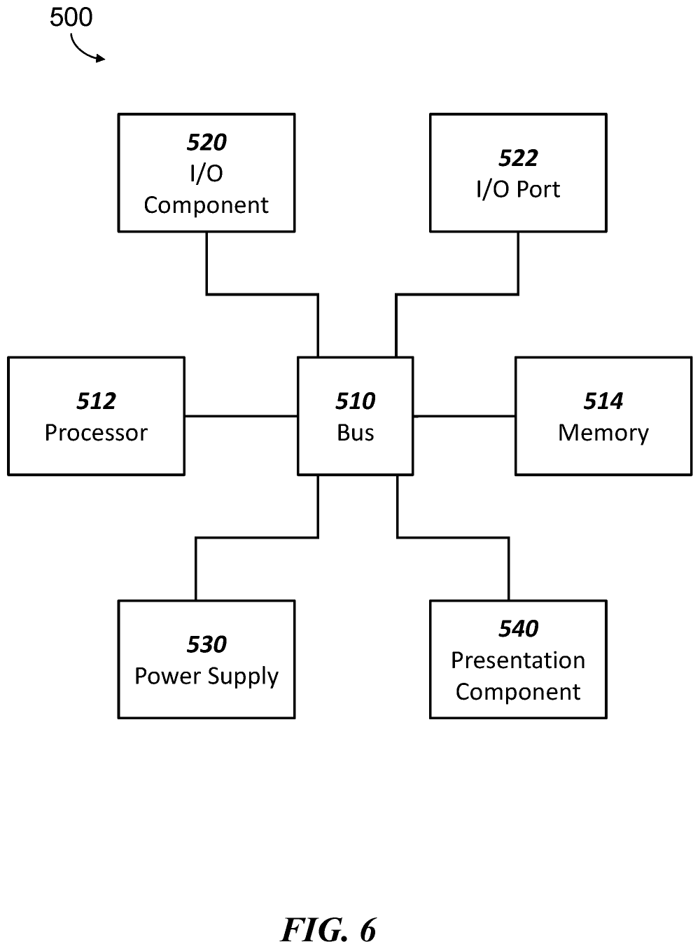

FIG. 6 depicts an example electronic computer, or computing device 500, that can be specially modified for use to implement one or more aspects of the present invention, including a reader 302 (refer to FIG. 5) and other such devices of a reusable container system 300 (refer to FIG. 5) as described herein. The functionality and hardware of such computing device 500 may be implemented in any of the electronic hardware systems or subsystems described herein as involving or using a “computer” or “computing device” or the like, or related hardware for providing all or part of the described functionality, provided as a separate device or integrated into a system or subsystem described herein, as would be appreciated and understood by those of skill in the art. The terms “computer”, “computing device”, and the like utilized herein are intended to mean a processor at its most basic form, on up to more complex computing systems, including servers and cloud-based systems, in accordance with conventional meanings of such terms. However, for purpose of completeness, example components and related accessories that are intended to be encompassed by the use of the terms “computer”, “computing device”, “processor”, and the like will be provided below in example nonlimiting form.

The computing device 500 is merely an illustrative example of a suitable specialized computing environment and in no way limits the scope of the present invention. An “electronic device”, “remote device,” or “personal electronic device” as represented in figures and description herein, can include a “workstation,” a “server,” a “laptop,” a “desktop,” a “hand-held device,” a “mobile device,” a “tablet computer,” a “processor,” or other computing devices, as would be understood by those of skill in the art. Given that the computing device 500 is depicted for illustrative purposes, embodiments of the present invention may utilize any number of computing devices 500 in any number of different ways to implement a single embodiment of the present invention. Accordingly, embodiments of the present invention are not limited to a single computing device 500, as would be appreciated by one with skill in the art, nor are they limited to a single type of implementation or configuration of the example computing device 500.

The computing device 500 can include a bus 510 that can be coupled to one or more of the following illustrative components, directly or indirectly: a memory 514, one or more processors 512, one or more presentation components 540, input/output ports 522, input/output components 520, and a power supply 530. One of skill in the art will appreciate that the bus 510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, the figures herein are merely illustrative of an exemplary computing device 500 that can be used to implement one or more embodiments of the present invention, and in no way limits the invention.

The computing device 500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 500.

The memory 514 can include computer-storage media in the form of volatile and/or nonvolatile memory. The memory 514 may be removable, non-removable, or any combination thereof. Exemplary hardware devices are devices such as hard drives, solid-state memory, optical-disc drives, and the like. The computing device 500 can include one or more processors 512 that read data from components such as the memory 514, the various I/O components 520, etc. The one or more processors 512 may be part of or otherwise used in implementing the reader 302 (refer to FIG. 5) or other such devices of the reusable container system 300 (refer to FIG. 5). Presentation component(s) 540 present data indications to a user or other device. Exemplary presentation components include a display device, speaker, printing component, vibrating component, etc.

The I/O ports 522 can enable the electronic or computing device 500 to be logically coupled to other devices, such as I/O components 520. Some of the I/O components 520 can be built into the computing device 500. Examples of such I/O components 520 include a sensor (including but not limited to: a camera, optical scanner, RFID scanner, or the like), keypad, touchpad, joystick, recording or storage device, game pad, satellite dish, scanner, printer, wireless device, networking device, and the like, as appropriate.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A reusable food or beverage container, comprising:
a bottom;
at least one side-wall extending from the bottom to define an interior volume and an upper opening at an opposite end of the at least one side-wall from the bottom;
wherein at least one surface of the container comprises a self-cleaning surface; and
an identification device incorporated into and associated with said reusable food or beverage container.

2. The reusable food or beverage container of claim 1, wherein an inner surface of said container is self-cleaning.

3. The reusable food or beverage container of claim 1, wherein a surface of a lip of said container is self-cleaning.

4. The reusable food or beverage container of claim 1, wherein an upper outer surface of said container is self-cleaning.

5. The reusable food or beverage container of claim 1, wherein an outer surface of said container is self-cleaning.

6. The reusable food or beverage container of claim 1, wherein said container includes a removable lid which substantially covers the upper opening.

7. The reusable food or beverage container of claim 6, wherein surfaces of said removable lid are self-cleaning.

8. The reusable food or beverage container of claim 6, wherein a portion of the surfaces of said removable lid are self-cleaning.

9. The reusable food or beverage container of claim 1, wherein said identification device comprises one or more of a bar code, a quick response (QR) code, a near-field communication (NFC) chip, a radio-frequency identification (RFID) tag, or a unique visual marking.

10. The reusable food or beverage container of claim 9, wherein said identification device associates the reusable food or beverage container to a data store containing information and preferences related to said reusable food or beverage container.

11. The reusable food or beverage container of claim 10, wherein said data store contains information to initiate automated processes associated with said reusable food or beverage container.

12. The reusable food or beverage container of claim 11, wherein said data store contains information to set parameters of said automated processes associated with said reusable food or beverage container.

13. The reusable food or beverage container of claim 1, wherein the self-cleaning surface comprises a superhydrophobic surface.

14. The reusable food or beverage container of claim 1, wherein the self-cleaning surface comprises a superoleophobic surface.

15. The reusable food or beverage container of claim 1, wherein the self-cleaning surface comprises a superhydrophilic surface.

16. The reusable food or beverage container of claim 1, wherein the self-cleaning surface comprises a photocatalytic surface.

17. The reusable food or beverage container of claim 1, wherein the identification device incorporated into and associated with said reusable food or beverage container is disposed in the bottom of the reusable food or beverage container.

18. The reusable food or beverage container of claim 1, wherein the identification device incorporated into and associated with said reusable food or beverage container is disposed in the at least one side-wall of the reusable food or beverage container.

19. The reusable food or beverage container of claim 1, wherein the reusable food or beverage container comprises a cup.

20. The reusable food or beverage container of claim 1, wherein the reusable food or beverage container comprises a take-out food container.
